(19) United States
(12) Patent Application Publication
(10) Pub. No.: US 2012/0221186 A1
(43) Pub. Date: Aug. 30, 2012

(54) Methods and Devices for Stabilizing an AGV during Transport of Elevated Loads

(75) Inventors: Vincent Bourquin, Territet (CH); Dominique Dériaz, Lausanne (CH); Michel Lyrstrand, Molndal (SE); Pontus Karlsson, Bromma (SE)

(73) Assignee: TTS PORT EQUIPMENT AB, Goteborg (SE)

(21) Appl. No.: 13/406,001

(22) Filed: Feb. 27, 2012

Related U.S. Application Data
(63) Continuation of application No. PCT/EP2011/052952, filed on Feb. 28, 2011.
(60) Provisional application No. 61/447,267, filed on Feb. 28, 2011.

(51) Int. Cl. B60B 39/00

(52) U.S. Cl. 701/23

(57) ABSTRACT

Methods and devices to physically stabilize a unit load of stapled unit loads such as at least two standard containers applied atop each other and on top of at least one Automatically Controlled Vehicle (AGV), during transport of the load in all directions on the ground. The AGV arranged below the unit load has at least one wheel-bogie having at least one wheel at each corner, the bogie being controllably pivotable at its geometrical center to a frame of the AGV with each wheel being controllably pivotable at its respective fixation points. During transport in a longitudinal direction of the total unit, each bogie is translated to a diagonal position in relation to its position of introduction as the wheels simultaneously are controlled so as to maintain their rolling direction in the direction of transport, so as to enhance the traction of the AGV.

This application claims the benefit of the filing dates of U.S. Provisional Patent Application No. 61/447,267 filed on Feb. 28, 2011, and International Application No. PCT/EP2011/052952 filed on Feb. 28, 2011, both of which are incorporated here by reference.

### BACKGROUND

The present invention relates to a method and a device to physically stabilize a load combination comprising stapled unit loads, such as at least two standard containers on top of each other or for instance loads loaded on pallets stacked on top of each other, and at least one Automatically or semi-automatically Guided Vehicle (AGV) below the loads, together with mechanisms for fixation thereof to each other and/or to the vehicle, during transport of the loads in all directions on the ground.

If the load is comprised of containers, they may be at least two standard containers (FEU=Forty feet Equivalent Unit containers or TEU=Twenty feet Equivalent Unit containers) applied one on top of another or in line, possibly both, possibly in a cassette and on top of at least one AGV. If more than one AGV is utilized, they are commonly controlled by common software. More specifically the invention deals with the issue of enhancing stability of such items (AGV+load), where the load is applied on/in and engaged to the upper side of a framework or cassette framework, the latter of which together lately has become named C-AGV, which is short for Cassette-AGV, being in turn on its bottom side on request carried by the AGV or the AGVs, each in tum comprising one or more bogies provided for the drivability of the whole unit. On top of each bogie, the frame of the AGV is provided with mechanisms for jacking (bringing the cassette into a transport position), for driving, and for braking.

The wheel-base and the traction of each bogie must at least in an initial position of introduction be held within the inner limits (as seen from above) of the transport system comprising the framework to be lifted and transported together with the loads. The transport system is mainly designed for use in ports or the like shunting areas, but can of course be scaled up or down for other more or less similar possible uses.

AGVs of the kind here meant are normally used in areas where transport of articles, such as containers of standardized volume, is frequently performed in large numbers, such as in ports or harbors. It is normally not allowed for people to stay in areas where loads of this kind are handled. Such areas are often heavy industrial applications where two or more AGVs may be utilized in order to be able to bear more load. When loads of standardized volume are stowed in height of at least two items at a time, it is required either to mechanically fix them to each other or to guide them in cell guides or the like. This creates or at least enhances a risk during transport of whole units of exposing them to unwanted momentum of inertia during actions such as start and stop of movement backward and forward, mostly, but also sidew²ays, stopping and turning during transport forward in curves, especially when exposed to heavy side winds.

Since demands on transport speeds and acceleration continuously over time are increased, this is of course troublesome. Combining different effects (e.g., side winds, side acceleration, vehicle dynamics, slope), whole loads are in the risk zone of turning over. Since staff handling standardized goods seldom are aware of the actual weight of each item (container or pallet) or for that matter its mass distribution, a unit load having a substantially higher or even unbalanced weight than another such load situated below it may be loaded atop a much lighter unit load. This imposes dangerous risks for instability of whole units (AGV+load), since the items are meant to be transported at speeds of up to at least 6 m/s in the main transport direction and up to between 2 and 3 m/s in directions sideways. Side forces that results can be considerable, especially if maximum turning radii are utilized and heavy winds are blowing. In the future, even higher transport speeds are to be expected, and thus the problems will become larger. Sideways acceleration or retardation in sideways transport of at least 1 m/s², most likely up until 6 m/s², for emergency operation in today's ranges of transport speed are in the range of possible figures. Collapses directly or indirectly due to these reasons are simply not an issue, due to the high demands on productivity. The goods to be transported simply must reach their respective destinations as soon as possible, preferably on time, and of course without any damage whatsoever.

As for the state of the art, it is relevant neither to the problem solved nor to the technical solution described in this application. Stiff steerable shafts or steerable wheels make no contribution whatsoever to the issue of stability.

For example, DE 102007050824A1 shows a towed vehicle for carrying a predetermined load, towed behind a lorry or the like. The vehicle in question comprises wheel pairs at distinct positions of the chassis thereof, being independently controllable so as to be able to maneuver the entire combination as well as possible.

Another example is WO 94/02890 where an AGV is depicted, which in order to be steerable and controllable comprises pairs of shafts at each end thereof which are individually pivotable in a horizontal plane.

The publication TTS Review, May 2009, p.14 gives a better picture of the state of the art as depicted in FIG. 9. There is shown an AGV for cassette handling. An AGV is introduced either sideways or longitudinally below a cassette supposed to encase at least two items, in this case containers, which may of course contain different items stapled at a stack with the same instability issues at hand. The AGV comprises wheel-pairs turnable 360°, which most certainly gives very good maneuverability, but gives absolutely no contribution when it comes to enhancing the stability of the load unit as such with its AGV. The publication is hereby incorporated here by reference.

Nothing is considered to deal with a problem that, even from the widest possible view, comes close to solving the problems addressed by this application.

### SUMMARY

An object of the present invention is therefore considered to lie in enhancing the stability of a unit comprising a flexibly integrated arrangement of loads (such as containers or pallets) indirectly and displaceably standing on the ground and atop each other to be randomly translated thereon. The loads can be either loaded on an AGV frame or on a cassette to constitute a unit to be transported. In the case of a load on a cassette, the vehicle can be driven in below the load, lift it, and drive away in any direction freely chosen.

According to aspects of the invention, the AGV to be arranged below the unit load is provided with at least one wheel-bogie, which in turn is provided with at least three wheels or pairs of wheels, the bogie being controllably pivotable in the horizontal plane in relation to a frame of the AGV while each wheel being controllably pivotable at its respective fixation point in relation to the bogie, whereby during transport in all possible directions of the load, each bogie can be translated to a position in relation to its position of introduction that the wheels define a considerably larger traction than they do when they are maintained in their initial position before pivoting of the bogie.

This gives the bogie or bogies of the AGV, with the use of thereto belonging control software, the possibility of being displaced to a position in which the traction of the bogie becomes wider than that of a drive-in width in relation to the load in its longitudinal direction, which with its containers, pallets or the like is to be lifted and transported to its future position. This enhances the stability of the whole unit both when transporting it at a given path longitudinally in curves, possibly affected by side-wind, and when transporting it in a direction 90° deviant to this direction and in all directions in between.

In embodiments shown below, frame beams of the AGV are there only to hold the bogies together as a common unit. 4. Provided an appropriate coordination of two independent bogies (that could be considered as a vehicle together), the function of the frame 4 can be taken by the cassette. The AGV has been provided with a jacking mechanism that independently acts directly on the unit loads and makes the total height of the transported unit loads lower, which also contributes to the transport stability of the unit as a whole.

Controllability is much improved by using the invention. The center of the turning radius of the complete unit can be translated to any point from directly below each of the pivot points of each bogie to any point in a very wide circumference to it.

According to a further embodiment of the invention, the bogies' main dimensions differ from each other in that the dimension as seen from above is rectangular instead of being essentially square. This means that the bogies when in line with the frames thereof are longer in that direction than in a direction 90° deviant from the same.

By controlling the angular position of each bogie to be a value of between 45° and 75° where the wheels are pivotable to an extent larger than +/−45°, it is possible to maximize the traction of the bogie even further. This will of course enhance stability of the complete unit even more. Finally, by an appropriate design of the wheels steering, an angular position of the bogie of 90° can be achieved, which during certain conditions allows to reach a better loading of the wheels in comparison to the 45° configuration.

### BRIEF DESCRIPTION OF THE DRAWINGS

The invention will in the following be described with reference to drawings of a preferred embodiment of the invention, in which:

FIG. 1 is a perspective view that shows an overview picture of the whole concept together with bogies of an AGV situated below a cassette, being controllable according to the invention,

FIG. 2 shows in a perspective view slightly from above a bogie of an AGV comprising two bogies having four wheels each, in a first stability enhancing position,

FIG. 3 shows a bogie of an AGV corresponding to that of FIG. 2 as seen from above,

FIG. 4 shows a bogie analogous to that of FIG. 3 seen in a perspective view slightly from above and in a normal transport position,

FIG. 5 shows a bogie of the same type, however, now from its front,

FIGS. 6a, 6b, 6c are schematic views of AGVs having their bogies and wheels displaced in different patterns,

FIGS. 7a, 7b, 7c, 7d, 7e are schematic views of a bogie of an AGV showing yet another lot of possible positions and patterns for the bogies and wheels,

FIGS. 8a, 8b, 8c, 8d each show different ways to displace the bogies and wheels when it is desired that an AGV is to “crab” in all directions between sideways and straight forward, and

FIG. 9 illustrates a cassette AGV according to the publication TTS Review, May 2009, used here as an example of prior art.

### DETAILED DESCRIPTION

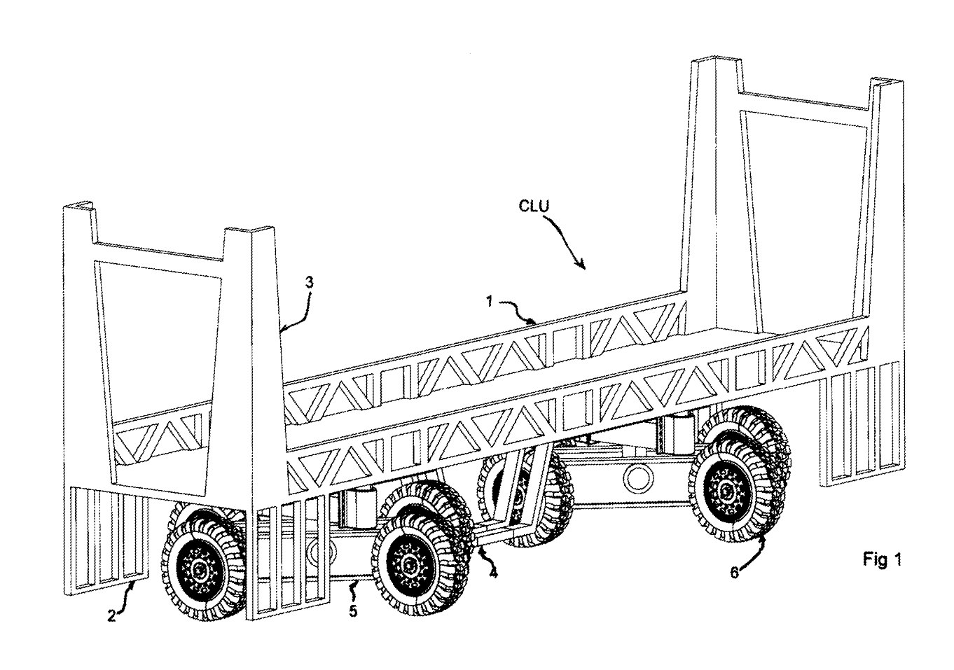

According to FIG. 1, there is shown a unit of what in this branch is called a Cassette Loading Unit CLU. Such a unit comprise a framework 1 made to be standing on the ground with legs 2, support pillars 3 and is preferably but not necessarily made from steel. Below this CLU is shown an Automatic Guided Vehicle AGV, comprising a framework 4 of its own being provided with bogies 5 at each end with four steerable wheels 6 each. The AGV is designed such that it may be driven in below the framework 1 either in the longitudinal direction of the framework or sideways. The framework 4 of the AGV is designed to between the bogies 5 contain an embedded driving unit (not shown), for instance a diesel engine, however, any possible unit may be used as such a driving unit (Otto with petrol, Otto with alcohol, electrical, inductive etc). The overall design of the CLU is standardized to fit certain measurements in areas such as harbors or large warehouses, where goods in large quantities are handled and stored.

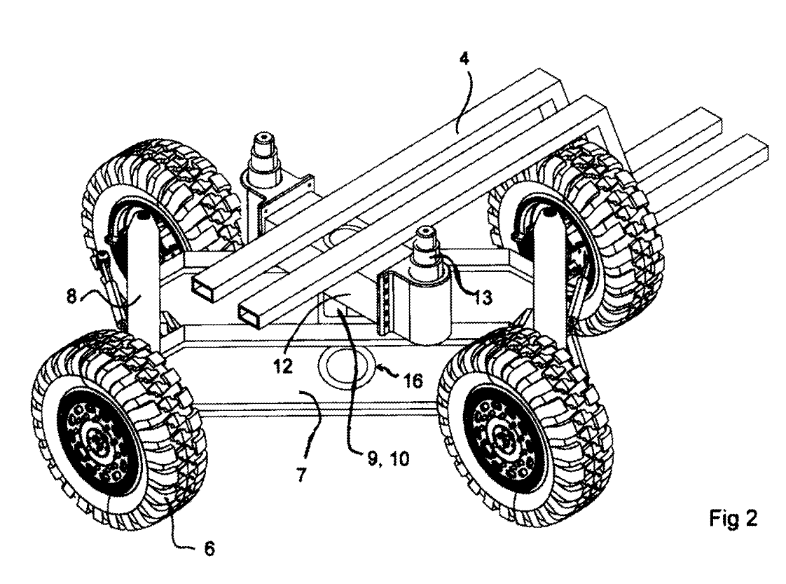

According to FIG. 2 a more detailed view in perspective, approximately 45° obliquely both seen from above and from the side of the framework 4 of the AGV, of a bogie 5 of an AGV is shown. It comprises sturdy main beams 7, at which ends the beams 7 are fixed by commonly known Chevron elements (sturdy rubber elements—not shown) or the like to crossbeams 8. At the ends of the beams 8 the wheels 6 are fixed to joints pivotable preferably 45″ and possibly some degrees more than 45° in each direction starting from an initial position corresponding to a normal transport direction straight forward in which the wheels are in line with the framework 4 as well as with the main beams 7. Between the main beams 7 at the middle of the respectively is another crossbeam 9 pivotably journalled at 16 to the main beams 7. Below the top surface 10 thereof there is a turning unit 11 having yet another beam 12 connected thereto being fixed to the main beams 7. The turning unit 11 is able to turn the bogie preferably 90° and possibly some degrees more than 90° in each direction. The beam 12 is in turn at its ends provided with a jacking mechanism or means 13 for interacting and locking to eviscerations (not shown) made on the bottom side of the framework 1 of the CLU. The jacking mechanism can be hydraulically, pneumatically, or electrically maneuvered. The same goes for the turning unit. All wheels 6 are steerably controlled under the influence of at least one tie rod 14 fixed between each wheel and its cross beam 8. These rods are like the turning unit of for that sake the jacking means driven hydraulically, pneumatically, or electrically in interaction with a main control system (not shown), containing algorithms for all possible positions of all the controllable parts.

The position of the AGV shown in FIG. 2 is one of two possible, however, identical stabilizing wheel and bogie positions for transporting the whole CLU sideways. This, however, means that the other bogie, situated at the other end of the frame, may be controlled to the same or its inverted identical position.

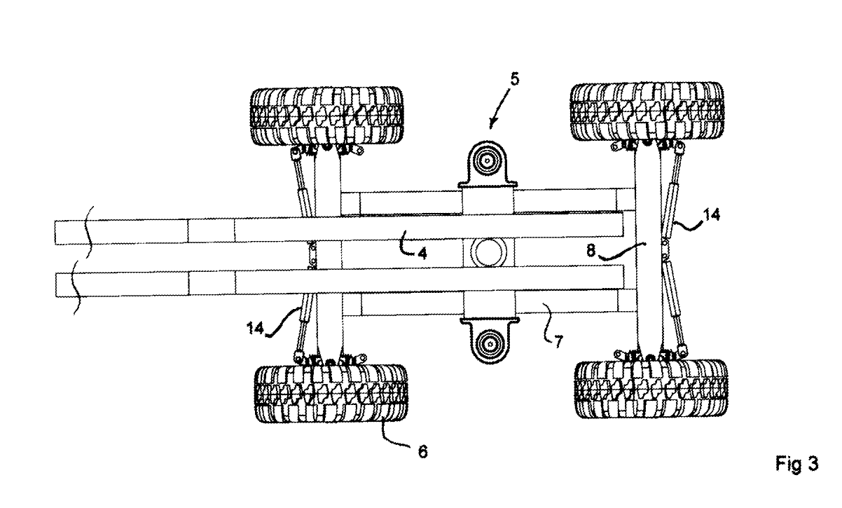

From FIG. 3, it is most clearly elucidated how the AGV-unit is built as it is shown from above. From the main beams 7 the cross beams 8 extend one at each end of the main beams out to its ends where the wheels 6 are arranged pivotably in a horizontal plane. The maximum pivotation of the wheels according to this embodiment is +/−45° and is affected by the controlled tie rods 14, which act simultaneously at a common command from a control unit (not shown). It is however contemplated that the wheels, if differently fixed to the bogie, might be made able to pivot as much as +/−180°. It should be noted that the bogie is either driven by one two or more wheels. Brakes are provided integrated in the rim area of the wheels. In the two wheel driven variant, two wheels are driven, while the other two are provided with brake units (not shown).

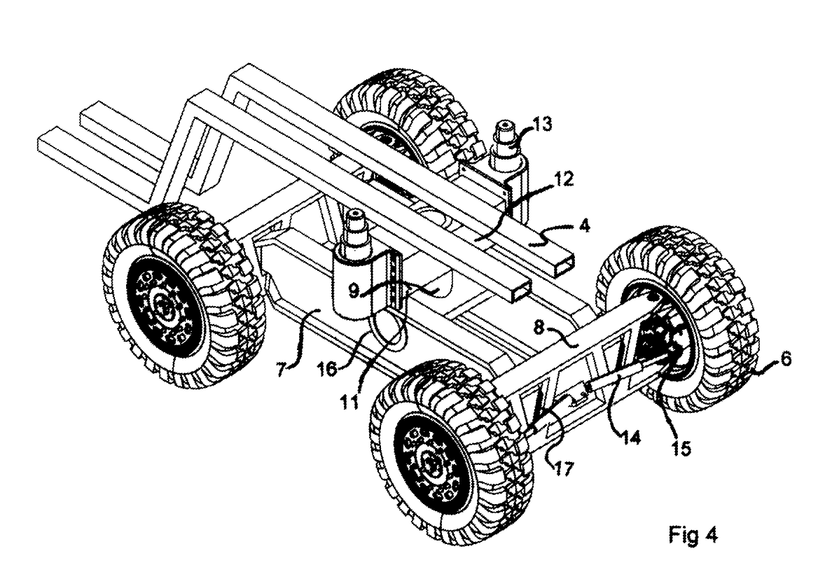

FIG. 4 shows the device according to the invention in a perspective close to that of FIG. 2, however, from another direction, In this case the bogie is in a different position corresponding to a normal driving position without the stabilization function initiated. Here also the wheel driving units together with its brakes 15 (as a unit) are shown. Inside the unit 12 there is a controllable swivel unit (not shown in detail) that enables the bogie to be pivoted in relation to its frame elements 4.

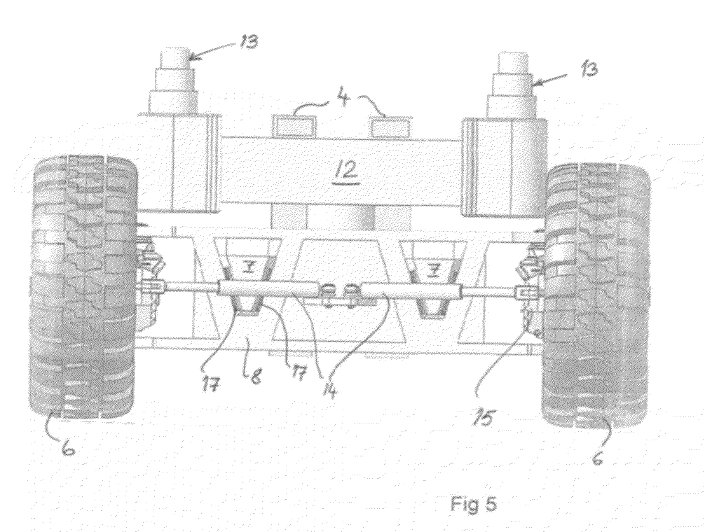

In order to show the device from all possible directions and in all possible positions FIG. 5 shows the bogie's front as a plane view. From this figure it is clearly evident that the beam 12 is snugly fitted to the below side of the main beams 7 thereby being used as a counter stay. From this figure is also clearly shown the previously mentioned rubber elements 17 (Chevron elements) which are situated in V-shaped eviscerations in such a fashion that all of the load loaded on the AGV from the containers press the rubber to a very stable relation, though loose. This is a solution well known from the railway industry, but gives the bogie a possibility to even out or even eliminate problems such as holes in or bumps on the ground of up to 100 mm.

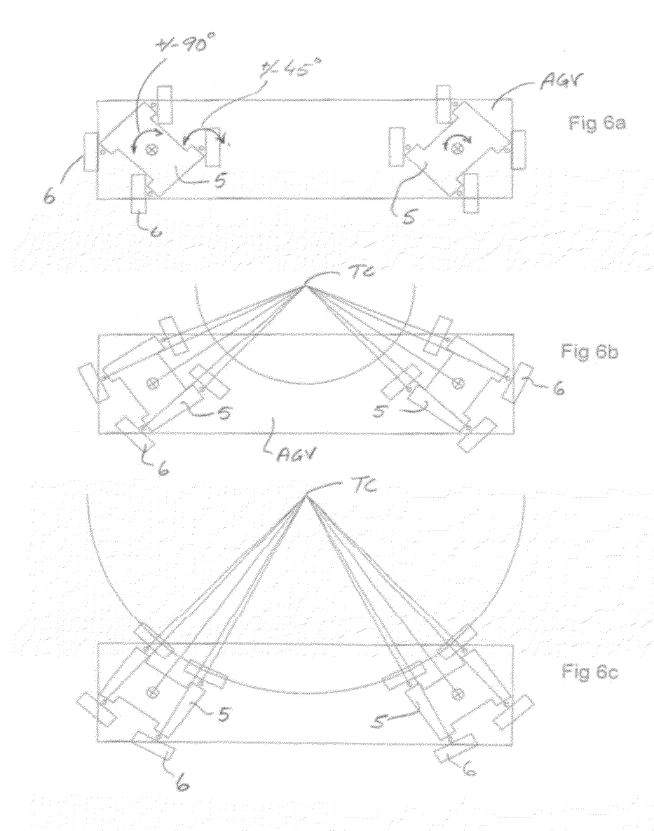

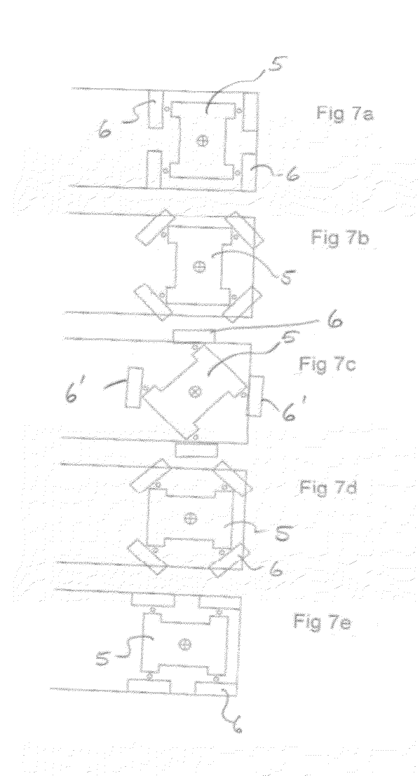

Below FIGS. 6a, 6b, 6c are described in a common context. According to FIG. 6a is shown one of three possible positions of the bogies 5 and wheels 6 thereof to achieve a sideways translational movement of the AGV. The bogies 5 are with regard to their centers pivoted 45°, clockwise for the left bogie in the figure, and counterclockwise for the right bogie in the figure. The second possibility in this context is to from the position shown pivot each bogie 5, 90° counterclockwise and clockwise while simultaneously turning each of the eight wheels 6 in concert with the movement of each bogie. The third and last possibility is to make a full 90° pivotation of each of the bogies (see FIG. 7a), while when this position has been achieved control the wheels to a position like their starting position, in which they are pivotable each +/−45°. To reach this third position an in between position like one of the positions shown in FIGS. 7b, 7c, 7d will have to be used. According to FIGS. 6b and 6c it is shown how the bogies and the wheels may be controlled to be positioned so as to move the turning center TC of the CLU. The center TC thus can be positioned anywhere on the ground, which as a bonus effect gives an extremely good maneuverability to the CLU.

FIGS. 7a, 7b, 7c, 7d, 7e show examples of different positions (as previously mentioned) of the bogies and wheels in comparison to the outer limitation of the cassette. Especially FIG. 7e shows a bogie with its wheels in their respective initial positions, enabling a CLU having two such bogies configured in the same way to be transported straight forwardly. In order to achieve a stability enhancing position for transport straight forward one would have to employ a position like the one shown in FIG. 7c and thereafter turn the wheels 6′ 90° clockwise. A quite considerable traction increase of twice the width of the wheels is thereby accomplished.

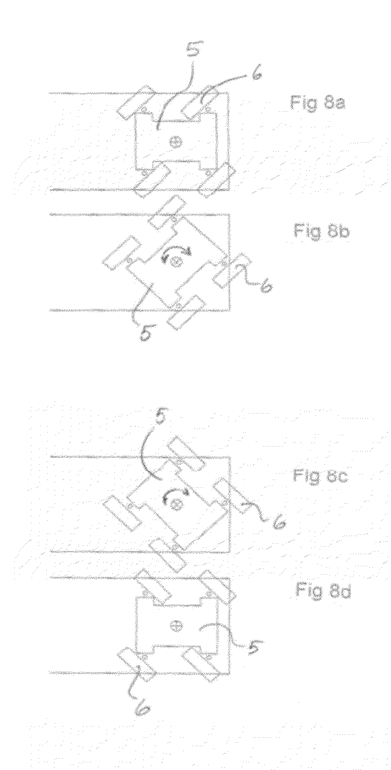

FIGS. 8a, 8b, 8c, 8d show different bogie and wheel configurations to accomplish a “crablike” movement of the whole CLU, which may be of use in certain circumstances.

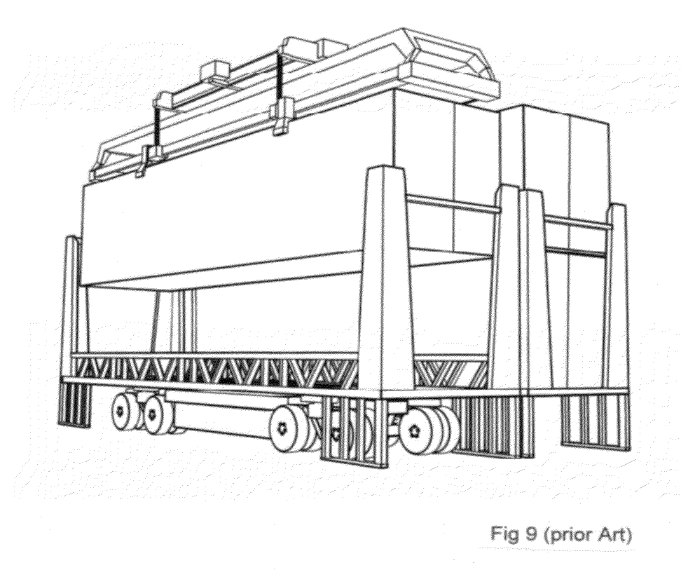

Finally, FIG. 9 shows a cassette AGV according to the prior art. In this context it should be specifically noted that the wheel pairs of the AGV shown in FIG. 9 all are pivotable +/−180°. They are therefore unable to deliver any contribution to enhance the stability of the AGV or for that matter of the whole CLU with an AGV situated below it.

The invention is not to be seen to be limited by the above described embodiment, but should instead be considered so by the enclosed patent claims and the description as a whole.

What is claimed is:

1. A method of physically stabilizing a load combination of unit loads, at least one automatically or semi-automatically guided driverless vehicle (AGV) beneath the unit loads, and one or more devices configured for fixing thereof to each other during transport of the load combination in all directions on the ground, comprising:
providing the AGV with at least one wheel-bogie having at least three wheels, the wheel-bogie being controllably pivotable in a horizontal plane in relation to a frame of the AGV, and each wheel being controllably pivotable at its respective tixation point;
whereby during transport of the load combination, each wheel-bogie can be pivoted to a position in relation to its starting position in which the wheels provide greater traction than they do when they are maintained in their starting positions before pivotation of the wheel-bogie.

2. The method of claim 1, wherein each wheel-bogie is pivotably arranged at its center as regarded perpendicularly to the horizontal plane, whereby an arc length of its pivotation becomes equal at all the wheels, thereby substantially equally distributing load at rest.

3. The method of claim 1, wherein the wheels of each wheel-bogie are simultaneously controlled regarding its angle of inclination so as to substantially maintain a rolling direction of each wheel in a direction of transport in order to enhance traction of the AGV.

4. The method of claim 1, wherein a total height of the unit loads is less and transport stability of the load combination is increased by having the wheel-bogies have frames that serve only to keep the AGV together and the AGV have a jacking mechanism that independently acts directly on the unit loads.

5. A stabilization device to physically control stability of a Cassette Loading Unit (CLU) having stacked unit loads within a loading cassette atop at least one automatically or semi-automatically controlled vehicle (AGV) configured for lifting and transporting the CLU on the ground, comprising:
at least one bogie fixed to a frame of the AGV and having at least three wheels,
a mechanism configured for positively controlling pivotation of both the bogie and the wheels in a horizontal plane, such that the bogie and the wheels are placed in positions that simultaneously enable transport in a given direction and that substantially maximizes stability of the CLU in the given direction and in any cross direction.

6. The device of claim 5, wherein the bogie comprises a mechanism configured for pivoting the bogie substantially +/−90°, and the wheels at their joints comprise mechanisms configured for pivoting the wheels substantially +/−45°.

7. The device of claim 5, wherein the wheels comprise mechanisms configured for pivoting the wheels substantially +/−180°.
